(19) United States
(12) Patent Application Publication
(10) Pub. No.: US 2024/0294118 A1
(43) Pub. Date: Sep. 5, 2024

(54) Auger Rack

(71) Applicant: M&M Manufacturing, Inc., Pine City, MN (US)

(72) Inventors: Jordan S. Flagstad, East Bethel, MN (US); Mark Murphy, Rush City, MN (US); Derek Murphy, Rush City, MN (US); Steve Larson, Askov, MN (US); Kevin Lind, Cambridge, MN (US); Curt Hill, Warba, MN (US)

(21) Appl. No.: 18/595,007

(22) Filed: Mar. 4, 2024

Related U.S. Application Data
(60) Provisional application No. 63/488,371, filed on Mar. 3, 2023.

(51) Int. Cl. B60R 9/00; A01K 97/01

(52) U.S. Cl. CPC B60R 9/00; A01K 97/01

(57) ABSTRACT

A rack for an auger is disclosed. The rack can have a body that is elongate along a longitudinal axis. A first mounting portion can extend from the body. The first mounting portion can defines a first receptacle that is configured to receive a portion of a shaft of the auger. Second and third mounting portions can be longitudinally spaced from the first receptacle. The second and third mounting portions can define second and third receptacles that are configured to receive respective portions of a handle of the auger. The second and third receptacles can be laterally spaced relative to each other along a transverse axis. A first retaining element can be configured to engage the auger to inhibit movement of the auger relative to the rack.

### CROSS-REFERENCE TO RELATED APPLICATION

This application claims priority to and the benefit of the filing date of U.S. Provisional Patent Application No. 63/488,371, filed Mar. 3, 2023, the entirety of which is incorporated herein by reference.

### FIELD

This disclosure relates generally to racks for mounting augers such as, for example and without limitation, ice fishing augers.

### BACKGROUND

Conventionally, augers for forming bores in ice (e.g., for ice fishing) are mounted to a vehicle using ad hoc means. For example, such augers can be held down in the bed of a vehicle (e.g., a utility task vehicle) with bungee cords, straps, or other such means. However, when held by these ad hoc means, the auger is prone to rotation about its longitudinal axis, particularly when the vehicle traverses bumpy terrain. Rotation of a gas auger about its longitudinal axis can cause the auger to lose gasoline or spill oil. Rotation of an electric auger about its longitudinal axis can allow the battery to come loose and fall off. Further, and more generally, these ad hoc means for securing an auger can put stress on and damage the auger, or, in some circumstances, can cause the auger to come unsecured and allow the auger to fall. Thus, a better way of securing an auger to a vehicle is desirable.

### SUMMARY

Described herein, in various aspects, is a rack for an auger. The auger can have at least one handle and a shaft. The rack can have a longitudinal axis and a transverse axis that is perpendicular to the longitudinal axis. The rack can comprise a body that is elongate along the longitudinal axis. A first mounting portion can extend from the body. The first mounting portion can define a first receptacle that is configured to receive a portion of the shaft of the auger. Second and third mounting portions can be longitudinally spaced from the first mounting portion. The second and third mounting portions can define second and third receptacles that are configured to receive respective portions of the at least one handle of the auger. The second and third receptacles can be laterally spaced relative to each other along the transverse axis. A first retaining element can be configured to engage the auger to inhibit movement of the auger relative to the rack.

Additional advantages of the invention will be set forth in part in the description that follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the invention will become more apparent in the detailed description in which reference is made to the appended drawings wherein:

FIG. 1 is a perspective view of an exemplary auger rack as disclosed herein.

FIG. 2 is another perspective view of a portion of the exemplary auger rack of FIG. 1.

FIG. 3 is another perspective view of the portion of the exemplary auger rack of FIG. 2.

FIG. 4 is another perspective view of the portion of the exemplary auger rack of FIG. 2.

FIG. 5 is a perspective view of an auger rack as disclosed herein with an auger thereon.

FIG. 6 is a perspective view of a padding for use with the auger rack.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “a fastener” can refer to one or more of such fasteners, and so forth.

All technical and scientific terms used herein have the same meaning as commonly understood to one of ordinary skill in the art to which this invention belongs unless clearly indicated otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, in some optional aspects, when values are approximated by use of the terms “substantially” or “generally,” it is contemplated that values within up to 15%, up to 10%, up to 5%, or up to 1% (above or below) of the particular value can be included within the scope of those aspects. When used with respect to an identified property or circumstance, “substantially” or “generally” can refer to a degree of deviation that is sufficiently small so as to not measurably detract from the identified property or circumstance, and the exact degree of deviation allowable may in some cases depend on the specific context.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

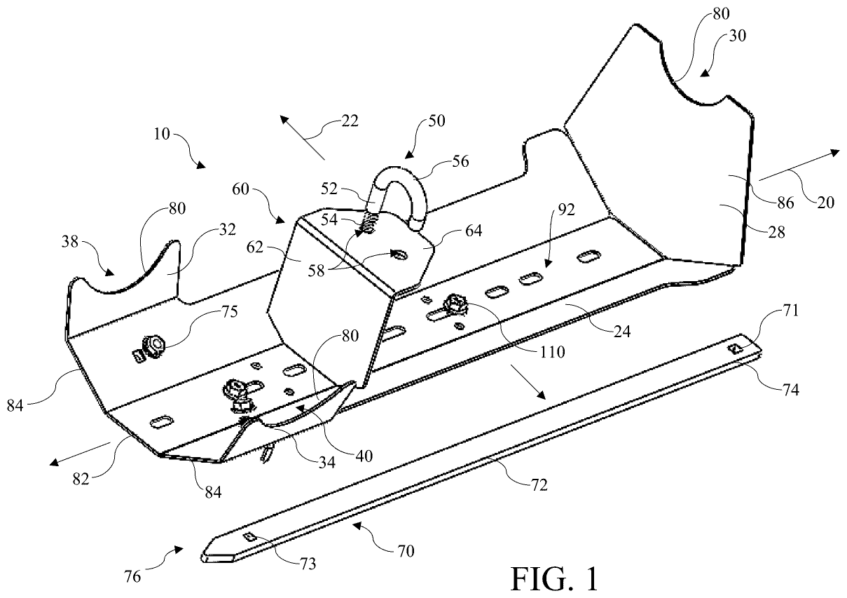

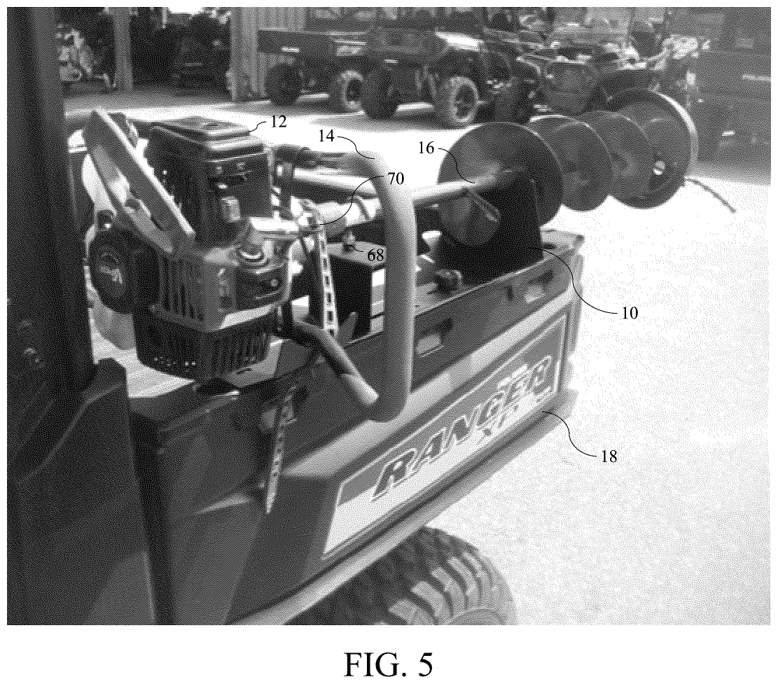

Disclosed herein with reference to FIGS. 1 and 5 is a rack 10 for an auger 12. The auger 12 can have a handle 14 (optionally, a plurality of handles) and a shaft 16. The auger 12 can optionally be an ice auger for forming holes in ice for ice fishing. However, it is contemplated that other augers and tools can be secured using the disclosed rack 10. The rack 10 can be configured for coupling (optionally, mounting) to a vehicle 18 such as, for example, a truck, an SUV, an all-terrain vehicle (ATV), a utility task vehicle (UTV), a snowmobile, a sled, or any other vehicle. Exemplary vehicles 18 include a DEFENDER UTV made by CAN AM, a VIKING UTV made by YAMAHA, or a RANGER UTV made by POLARIS. As used herein, the term “rack” is not used in a limiting sense. Rather, the term “rack” is intended to refer to any coupling (e.g., mounting) structure having the features disclosed and/or claimed herein.

The rack 10 can have a longitudinal axis 20 and a transverse axis 22 that is perpendicular to the longitudinal axis. The rack 10 can comprise a body 24 that is elongate along the longitudinal axis 20. A first mounting portion 28 can extend from the body 24. The first mounting portion 28 can define a first receptacle 30 that is configured to receive a portion of the shaft 16 of the auger 12. The rack 10 can further comprise second and third mounting portions 32, 34 are longitudinally spaced from the first mounting portion 28 (and first receptacle 30) along the longitudinal axis 20. The second and third mounting portions 32, 34 can define second and third receptacles 38, 40 that are configured to receive respective portions of the handle(s) 14 of the auger 12. The second and third receptacles 38, 40 can be laterally spaced relative to each other along the transverse axis 22. The second and third receptacles 38, 40, by receiving the handle(s) 14 and being spaced along the transverse axis 22, can inhibit rotation of the auger 12 along its longitudinal axis. As used herein, the term “receptacle” refers to any open area or space that is configured to receive at least a portion of another structure.

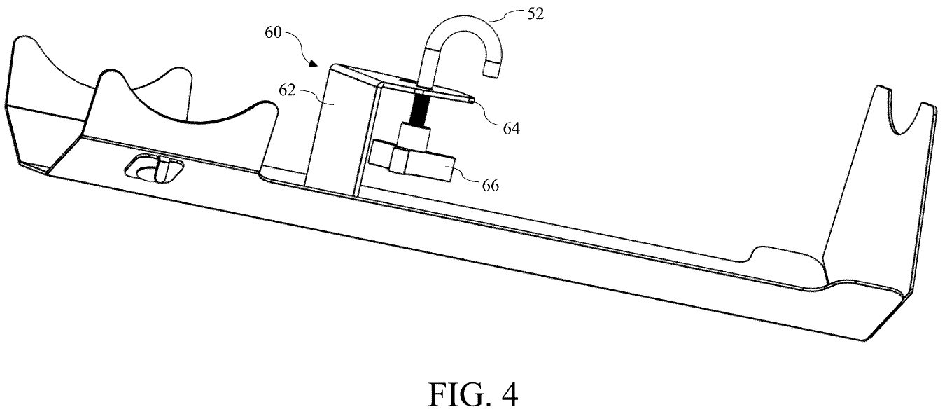

Referring to FIGS. 1 and 4, a first retaining element 50 can be configured to engage the auger 12 to inhibit movement of the auger relative to the rack 10. Optionally, the first retaining element 50 can comprise a J-hook 52. The J-hook 52 can have a threaded stem 54 and a U-shaped portion 56 that extends from the threaded stem. The rack 10 can define an opening 58 that receives therethrough the threaded stem 54 of the J-hook 52. The J-hook 52 can be positioned between the first mounting portion 28 and the second and third mounting portions 32, 34 along the longitudinal axis 20.

In some aspects, and as shown in FIG. 1, the rack 10 can comprise a support 60 (e.g., a sheet metal support) comprising a first portion 62 that couples to and extends vertically from the body 24 and a flange portion 64 that extends from a top end portion of the first portion (e.g., at 90 degrees or about 90 degrees). The flange portion 64 of the support 60 can define the opening 58 that receives therethrough the threaded stem 54 of the J-hook 52. As shown in FIG. 4, a nut 66 (e.g., a threaded through-hole knob, as illustrated) can be tightened down against an underside of the flange portion 64 to pull the J-hook 52 down against the shaft 16 of the auger 12. A jam nut 68 (FIG. 5) can be tightened down on an opposing top surface (opposite the jam nut) of the flange portion 64 of the support 60 to inhibit loosening of the J-hook 52.

In some aspects, and as shown in FIG. 1, the flange portion 64 of the support 60 can define a pair of openings 58 that are spaced along the transverse axis 22 so that the pair of openings are on opposing sides of the rack 10 relative to a reference plane (e.g., a vertical plane) that is parallel to the longitudinal axis 20 and bisects the rack. In this way, the J-hook 52 can be positioned on either side of the rack 10.

It is contemplated that the first retaining element 50 comprising a J-hook 52 can be effective and economical. However, other embodiments are contemplated. For example, in further aspects, the first retaining element 50 can be a clamp that extends over, and biases against, the auger 12. Said clamp can comprise a rigid element that biases against the auger 12. In further aspects, the first retaining element 50 can comprise a flexible (optionally, elastic) strap. For example, in some aspects, the first retaining element 50 can comprise a compression strap having a ratchet for tightening the strap against the auger 12. In still further aspects, first retaining element 50 can comprise an elastic strap that is pulled against the auger and held in tension against the auger (e.g., as described herein in reference to the second retaining element). It is contemplated that the first retaining element 50 can apply a force against the auger 12 to force the auger 12 into and against the first, second, and third receptacles 30, 38, 40.

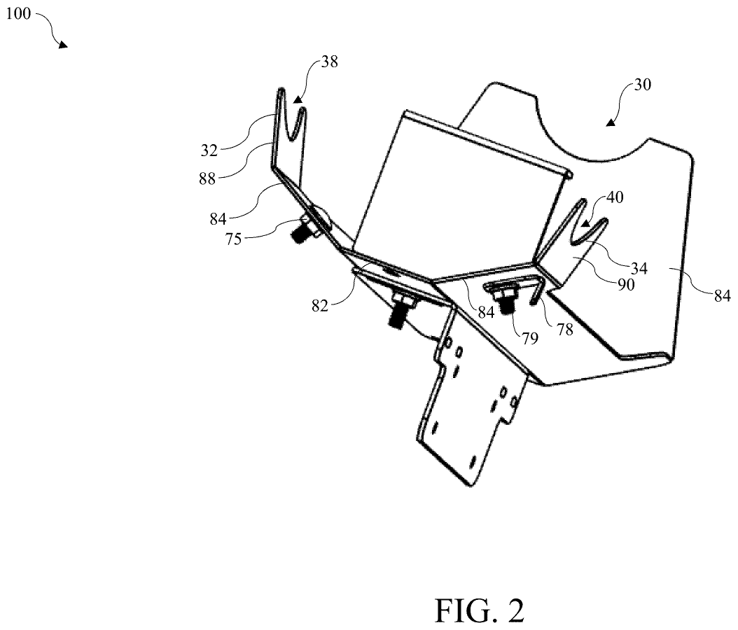

Referring to FIGS. 1-2 and 5, the rack 10 can further comprise a second retaining element 70 that is configured to engage (e.g., bias against) the auger 12 to inhibit movement of the auger relative to the rack. In some aspects, the second retaining element 70 can comprise a strap 72 having a first end portion 74 and an opposed second end portion 76. The strap 72 can be an elastic strap. The first end portion 74 of the strap 72 can be coupled to the body 24 (e.g., via a fastener 75 extending through the body 24 of the rack 10 and through a hole 71 in the strap). The rack 10 can further comprise a hook 78. For example, in some aspects, the hook 78 can be coupled to an underside of the body 24 via a fastener 79. The second end portion 74 of the strap 72 can define a hole 73 that is configured to receive the hook 78 therethrough. In exemplary aspects, the strap 72 can comprise a plurality of holes 73 spaced along its length. In use, the first and second end portions 74, 76 of the strap 72 can be positioned on opposite sides of the reference plane that bisects the body, with the strap extending around the auger 12. In this way, a user can select the tension of the strap 72 against the auger 12 as well as accommodate different auger shapes. In some aspects, the second retaining element 70 can be positioned between the first retaining element 50 and the second and third mounting portions 32, 34 along the longitudinal axis 20.

Optionally, the strap 72 of the second retaining element 70 can comprise a flexible strap (e.g., a nylon strap) that can be tightened against the auger 12. For example, the second retaining element 70 can comprise a strap 72 and a ratchet that can tighten the strap against the auger. In yet further aspects, the second retaining element 70 can comprise a rigid member that engages the rack, such as, for example, a rigid clamp.

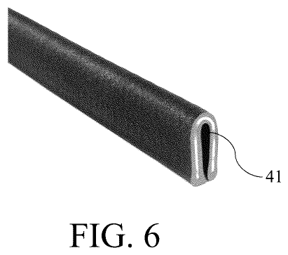

In some aspects, one or more of the first, second, and third receptacles 30, 38, 40 can comprise a respective arcuate edge 80 of the first, second, and third mounting portions 28, 32, 34, respectively. The arcuate edges 80 can be concave. In exemplary aspects, the arcuate edge 80 of the first receptacle 30 can have a radius of curvature from about 1 to about 2.5 inches (e.g., about 1.5 inches). In exemplary aspects, the arcuate edge 80 of each of the second and third receptacles 38, 40 can have a radius from about 1 to about 5 inches (e.g., about 2.25 inches). Thus, the auger 12 can rest at the lowest portion of each of the first, second, and third receptacles 30, 38, 40 along a vertical axis 23 that is perpendicular to each of the longitudinal and transverse axes 20, 22. The position of the receptacles can be defined by their respective lowest portions. In exemplary aspects, the second and third receptacles 38, 40 can be spaced from each other along the transverse axis 22 by from about 4 inches to about 12 inches (e.g., about 7 inches). The second and third receptacles 38, 40 can be spaced from the first receptacle 30 along the longitudinal axis by from about 10 inches to about 30 inches (e.g., about 20 inches). Although shown as arcuate edges, it is contemplated that the first, second, and third mounting portions 28, 32, 34 can further comprise other geometries, such as rectangular edges, cylindrical sleeves, or any suitable shape for receiving and supporting the respective portions of the auger. Further, referring also to FIG. 6, a padding material 41 such as, for example but without limitation, foam polymer, can form one or more of the first, second, and third receptacles 30, 38, 40. For example, a foam polymer strip can be positioned over the arcuate edges 80 and, optionally, glued, mechanically fastened with fasteners (e.g., screws), or otherwise attached to the first, second, and third mounting portions 28, 32, 34. The padding material can extend across the first, second, and third receptacles 30, 38, 40 and can be configured to couple to (e.g., adhere to) portions of the first, second, and third mounting portions 28, 32, 34. The padding material 41 can optionally have a U-shaped profile that extends across the first, second, and third receptacles 30, 38, 40. An exemplary padding material can be TRIM LOC padding provided by Trim Loc Inc.

In some optional aspects, the body 24 can comprise sheet metal. In exemplary, optional aspects, the sheet metal can be between 10 gauge and 16 gauge (e.g., 12 gauge). The body 24 can comprise for example, steel, stainless steel, or aluminum. The rack 10, or a portion thereof, can be painted or powder coated (e.g., with a durable texture/matte finish). For example, as shown in FIG. 1, the body 24 can comprise a base portion 82 and a pair of side flanges 84 that extend longitudinally along the base portion. The side flanges 84 can extend from the base portion at an angle (e.g., from about 30 degrees to about 60 degrees, or about 45 degrees). The side flanges 84 can provide rigidity to the rack 10. Further, the side flanges 84 can extend outwardly to position the second, and third receptacles 38, 40 sufficiently laterally outwardly to support the auger 12 and inhibit rotation thereof. The first mounting portion 28 can comprise an end flange 86 that extends vertically from the base portion 82. The second and third mounting portions 32, 34 can comprise respective flanges 88, 90 that extend vertically from respective side flanges of the pair of side flanges. The first, second, and third receptacles 30, 38, 40 can be defined by formed (e.g., cut) edges of the end flange 86 and flanges 88, 90.

In further aspects, the rack 10 can comprise polymer instead of, or in addition to, sheet metal. For example, some or all of the rack 10 can comprise or consist of injection-molded components.

The body 24 (e.g., the base portion 82) can define a hole pattern 92 that is configured to receive mounting hardware. In some aspects, the hole pattern 92 can define holes that are configured (e.g., spaced and sized) to receive mounting hardware for coupling the rack 10 to a particular vehicle (or a plurality of particular vehicles). For example, a particular make and model of a vehicle (e.g., UTV) can have a bed with a corresponding hole pattern that can receive screws or other mounting hardware therethrough for mounting various devices. In yet further aspects, holes can be drilled or otherwise formed into a vehicle (e.g., into a truck bed) for receiving screws or other mounting hardware.

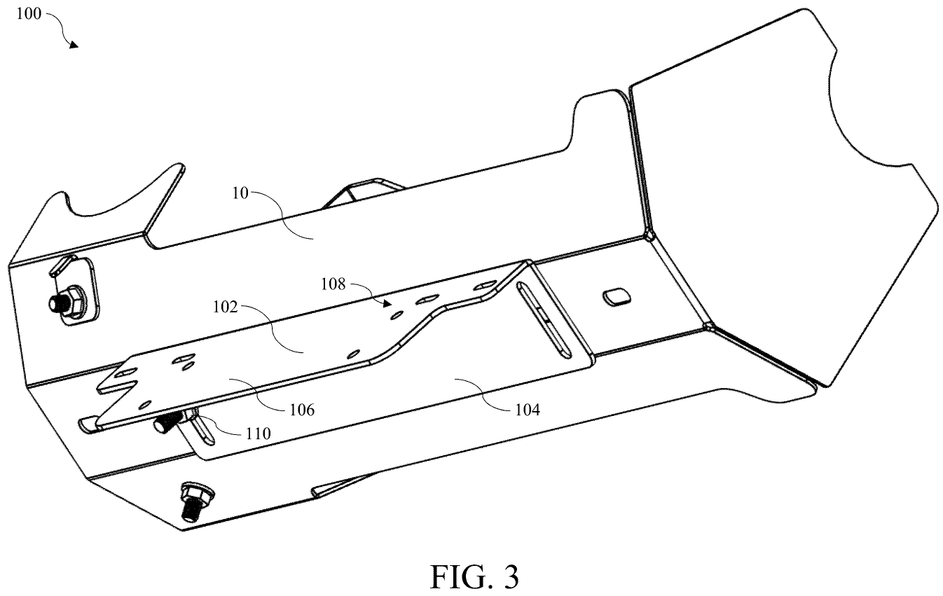

In further aspects, as shown in FIG. 3, an adapter plate 102 can be used to couple the rack 10 to one or more particular vehicles. For example, the adapter plate 102 can define a first portion 104 that is configured to couple to the body 24 (e.g., to the base portion 82). A second portion 106 of the adapter plate 102 can define a hole pattern 108 that is configured to mate with a hole pattern of a particular vehicle (or a plurality of particular vehicles). For example, exemplary brackets 102 can be configured to mate with a DEFENDER UTV made by CAN AM, a VIKING UTV made by YAMAHA, or a RANGER UTV made by POLARIS. The second portion 106 of the adapter plate 102 can extend away from the first portion 104 at an angle (e.g., between 60 degrees and 120 degrees, or about 90 degrees).

In exemplary aspects, a kit 100 can comprise a rack 10 and a mounting bracket 102. The kit 100 can further comprise mounting hardware 110 (e.g., nuts and bolts, screws, clamps, rivets, or any suitable fasteners) that is configured to couple the mounting bracket to the rack 10. The kit 100 can further comprise hardware for coupling the bracket to the vehicle 18.

In still further aspects, the rack 10 can be mounted on a wall, a bench, a floor, or other surface in a facility for storage, such as, for example, a garage, basement, or storage unit. It is contemplated that the hole patterns described herein can receive lag bolts that extend into a lumber element (e.g., a wall stud or a wooden bench) so that the rack 10 can be mounted to said lumber element.

Although the foregoing invention has been described in some detail by way of illustration and example for purposes of clarity of understanding, certain changes and modifications may be practiced within the scope of the appended claims.

What is claimed is:

1. A rack for an auger, the auger having at least one handle and a shaft, the rack having a longitudinal axis and a transverse axis that is perpendicular to the longitudinal axis, the rack comprising:
a body that is elongate along the longitudinal axis;
a first mounting portion that extend from the body, wherein the first mounting portion defines a first receptacle that is configured to receive a portion of the shaft of the auger;
second and third mounting portions are longitudinally spaced from the first receptacle, wherein the second and third mounting portions define second and third receptacles that are configured to receive respective portions of the at least one handle of the auger, wherein the second and third receptacles are laterally spaced relative to each other along the transverse axis; and
a first retaining element that is configured to engage the auger to inhibit movement of the auger relative to the rack.

2. The rack of claim 1, wherein the first retaining element comprises a J-hook, the J-hook having a threaded stem and a U-shaped portion that extends from the threaded stem, wherein the rack defines an opening that receives therethrough the threaded stem of the J-hook, wherein the J-hook is positioned between the first mounting portion and the second and third mounting portions along the longitudinal axis.

3. The rack of claim 1, further comprising a second retaining element that is configured to engage the auger to inhibit movement of the auger relative to the rack.

4. The rack of claim 3, wherein the second retaining element comprises a strap having a first end portion and an opposed second end portion.

5. The rack of claim 4, wherein the first end portion of the strap is coupled to the body, wherein the rack defines a hook, wherein the second end portion defines an opening that is configured to receive the hook therethrough.

6. The rack of claim 1, wherein each of the first, second, and third receptacles comprises a respective arcuate edge of the first, second, and third mounting portions, respectively.

7. The rack of claim 1, wherein the body comprises sheet metal.

8. The rack of claim 7, wherein the body comprises a base portion, wherein the first mounting portion comprises an end flange that extends vertically from the base portion.

9. The rack of claim 8, wherein the body comprises a pair of side flanges that extend longitudinally along the base portion.

10. The rack of claim 9, wherein the second and third mounting portions comprise respective flanges that extend vertically from respective side flanges of the pair of side flanges.

11. The rack of claim 8, wherein the base portion defines a hole pattern that is configured to receive mounting hardware.

12. The rack of claim 8, wherein the first retaining element comprises a J-hook, the J-hook having a threaded stem and a U-shaped portion that extends from the threaded stem.

13. The rack of claim 12, further comprising a support comprising a first portion that couples to and extends vertically from the base portion and a flange portion that extends from the first portion.

14. The rack of claim 13, wherein the flange portion of the support defines an opening that receives therethrough the threaded stem of the J-hook.

15. The rack of claim 14, wherein the J-hook is positioned between the first mounting portion and the second and third mounting portions along the longitudinal axis.

16. A kit comprising:
a rack as in claim 1; and
an adapter plate that is configured to couple to the body.

17. The kit of claim 16, wherein the adapter plate defines a first portion that is configured to couple to the body and a second portion that defines a hole pattern, wherein the hole pattern is configured to mate with a hole pattern of a particular vehicle.
